(19) United States
(12) Patent Application Publication
(10) Pub. No.: US 2005/0067445 A1
(43) Pub. Date: Mar. 31, 2005

(54) Coat hanger, method for manufacturing a coat hanger and metal hook for a coat hanger

(75) Inventor: Jan Cornelis De Groot, Mijnsheerenland (NL)

Correspondence Address: YOUNG & THOMPSON, 745 SOUTH 23RD STREET, 2ND FLOOR, ARLINGTON, VA, 22202, US

(73) Assignee: MAINETTI BV, HELMOND (NL)

(21) Appl. No.: 10/964,727

(22) Filed: Oct. 15, 2004

Related U.S. Application Data
(63) Continuation of application No. PCT/EP02/04190, filed on Apr. 15, 2002.

(51) Int. Cl. H01R 33/94; H01R 33/92; H01R 33/88; H01R 27/02

(52) U.S. Cl. 223/85

(57) ABSTRACT

Coat hanger made of plastic 81), provided with a steel hook (4). The steel hook (4) can be rotated inside the plastic (1), without deteriorating the plastic (1). Between the hook (4) and the platic (1) a well-defined frictional torque is present, due to which a previously determined torque is necessary for turning the hook (4). The friction is realised by deforming the pin-shaped part (7) of the hook (4) which is situated inside the plastic (1).

The invention relates to a coat hanger, provided with a plastic body and a metal hook, which hook has a pin-shaped part which is mounted for rotation round a longitudinal axis in a centrally located cavity in the plastic body, with the foot anchoring the hook in the plastic body.

A coat hanger of this type is known from U.S. Pat. No. 4,739,912. In the known coat hanger, an extremity of the centrally located cavity is given a wider diameter. The diameter of the centrally located cavity itself is chosen such that the foot can be pushed through it and to land in the part with the wider diameter. In this manner, a coat hanger is realised of which the hook may rotate freely.

The coat hanger according to the invention is specially designed to be used for the transport of large amounts of clothing, in the process of which large piles of clothing are taken for example from a rail in a van and then hung up on a rack. This is possible only when the hooks do not turn. At a later stage, when the clothing hangs in a shop for example, it is practical if the hooks can be turned. The inventive coat hanger solves this apparent dilemma, and is for that purpose characterized in that the pin-shaped part is provided with friction means, for realising a predetermined friction between the hook and the plastic body. Thereby the friction is chosen such that an involuntary rotation of the hook is quite impossible.

From EP-A-0 409 023 a coat hanger is known with a foot, provided with radiallyextending grooves, which would mean that it may rotate freely. In order to prevent the hook from rotating, a few bridges have been left between the grooves. This means that the hook may be turned if a relatively large force is exerted onto it, such that the bridges between the grooves break out. Once this has happened, the hook may be turned a limited number of times, after which the plastic round the foot rapidly crumbles to such an extent that the hook may get loose. The known coat hanger in fact does solve the problem, but it cannot be reused, because after it has been used once, it usually can rotate freely. This single use aspect is no longer considered acceptable from an economical point of view and from an environmental point of view.

A favourable embodiment of the inventive coat hanger, in which the friction is at least substantially obtained by utilising the elasticity of the plastic, is characterized in that the friction means comprise a mechanical deformed part of the pin-shaped part. According to an aspect of the invention, the pin-shaped part must have a length of at least 20 mm, in order to be able to accommodate this mechanical deformed part in the pin-shaped part.

A first favourable realisation of the inventive coat hanger is characterized in that the pin-shaped part has at least partly a non-round cross section. This non-round part will stick in the centrally located cavity and will elastically deform the centrally located cavity when it is turned, which results in a well defined friction without causing any significant wear.

A second favourable embodiment of the inventive coat hanger is characterized in that the pin-shaped part is at least partly provided with an arc-shaped deformation in a longitudinal direction. The centrally located cavity in which this mechanically deformed pin-shaped part is situated, will try to nullify the deformation when the hook is rotated inside the coat hanger, in the process of which the centrally located cavity and partly also the pin-shaped part will elastically deform, which produces the desired friction.

A very favourable realisation of the inventive coat hanger is characterized in that the foot is provided with radiallyextending grooves and the plastic body with complementary grooves. It turns out that especially in combination with the arc-shaped deformation an additional and reproducible friction is obtained between the radiallyextending grooves and the complementary grooves.

A further favourable embodiment of the inventive coat hanger, which gives an extended operational life, is characterized in that at least a part of the plastic body which co-operates with the pin-shaped part is made of an elastic plastic, like polypropylene, polyethylene or a styrene-butadiene-styrene with polystyrene mixture.

The invention also relates to a hook for a coat hanger as previously described.

The invention also relates to a method for manufacturing a coat hanger, in the process of which a plastic body is made, provided with a centrally located cavity to which a steel hook can be inserted. In order to give the hook a well defined friction when rotated in a coat hanger thus obtained, the invention is characterized in that a metal hook is made, provided with a pin-shaped part with a length of at least 20 mm, that the pin-shaped part, possibly after being heated, is pressed into the centrally located cavity and that the pin-shaped part is mechanically deformed over substantially its entire length before being pressed into the centrally located cavity.

A favourable realization of the inventive method which makes it easier to place the pin-shaped end into the centrally located cavity, is characterized in that the mechanical deformation is performed in such a manner that an end of the pin-shaped part is not displaced in a radial direction.

The invention will now be further explained with a reference to the following figures, in which:

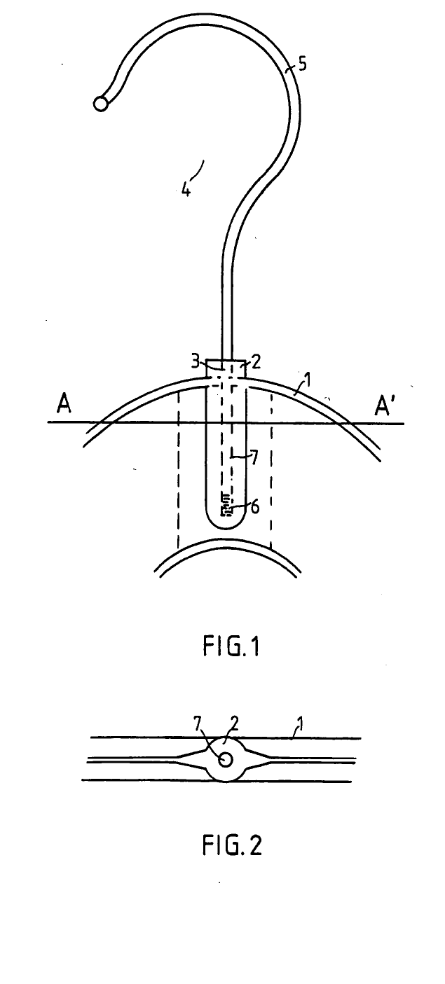

FIG. 1 represents a first embodiment of a coat hanger according to the invention;

FIG. 2 represents in cross-section this embodiment;

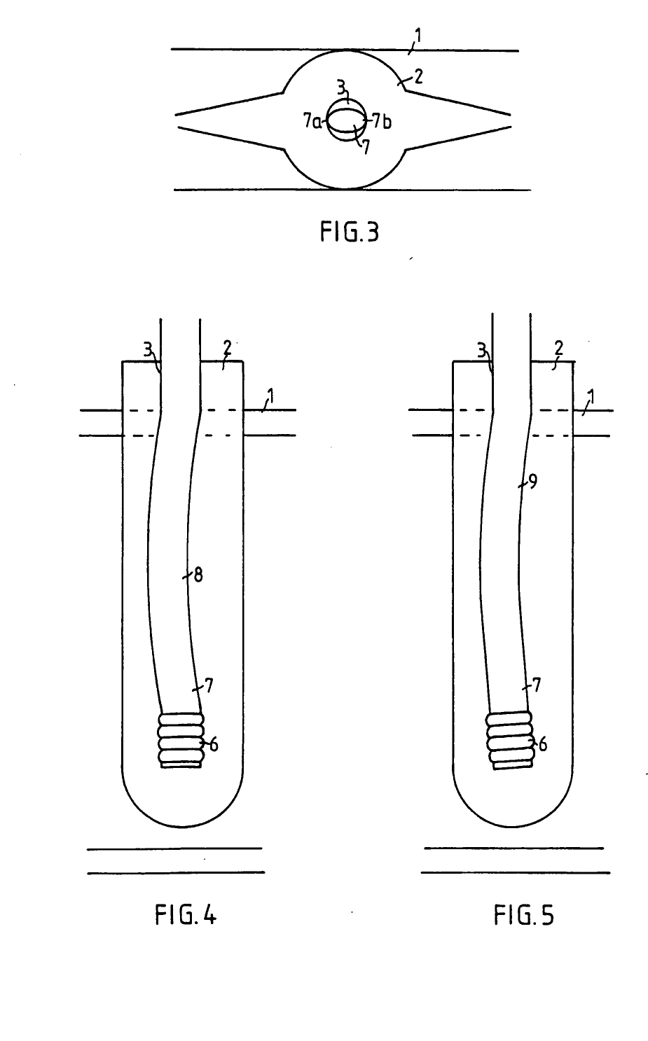

FIG. 3 represents in cross-section a possible elliptically shaped deformation if the pin-shaped part;

FIG. 4 represents a possible arc-shaped deformation of the pin-shaped part;

FIG. 5 represents a further possible arc-shaped deformation of the pin-shaped part;

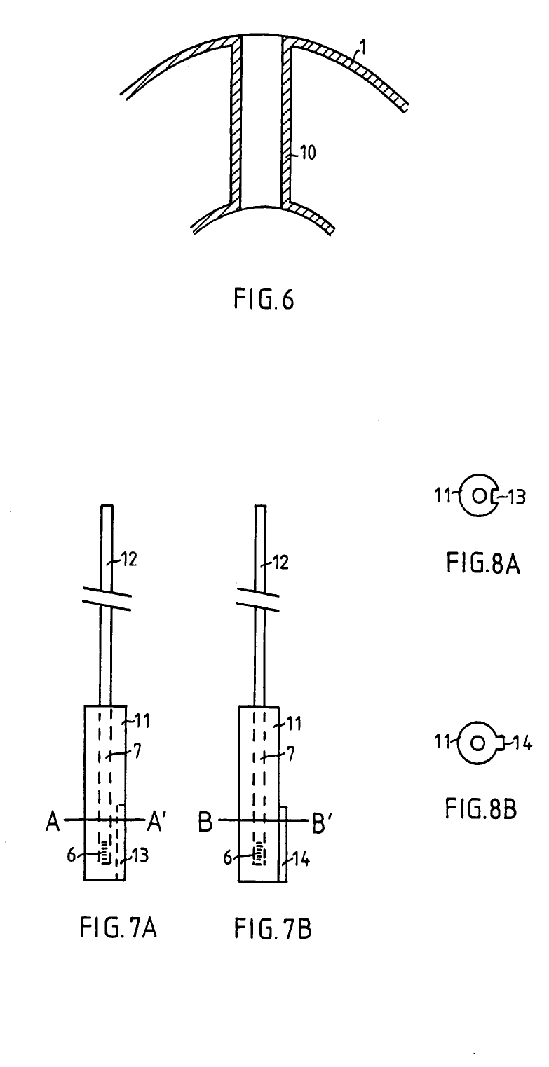

FIG. 6 represents in cross-section a further possible embodiment of a plastic body;

FIG. 7A represents in side view a plastic plug provided with a steel pin and a recess;

FIG. 7B represents in side view a plastic plug provided with a steel pin and a projection;

FIG. 8A represents in cross-section the plastic plug according to FIG. 7A;

FIG. 8B represents in cross-section the plastic plug according to FIG. 7B.

FIG. 1 represents an embodiment of a coat hanger according to the invention, in which a plastic body 1 is provided with a cylindrically shaped reinforcement 2, in which a centrally located cavity 3 has been made, in which in turn a steel hook 4 is placed, provided with a hook-shaped part 5, a foot 6 and a pin-shaped part 7. Foot 6 consists here of a set of radiallyextending grooves, made in the end of the pin-shaped part, which grooves prevent steel hook 4 from being pulled out of plastic body 1. Hook 4 and plastic body 1 are produced separately, while the centrally located cavity 3 is made in plastic body 1 during its production. For the manufacture of hook 4, a length of wire-shaped base material is provided with hook-shaped part 5 and foot 6, between which a pin-shaped part 7 is situated. Possibly after being heated, foot 6 and pin-shaped part 7 are pressed into centrally located cavity 3. Before pin-shaped part 7 is pressed into centrally located cavity 3, pin-shaped part 7 is according to the invention mechanically deformed, which means that a deviation of the pure cylindrical shape of the wire-shaped base material is made. Pin-shaped part 7 is also longer than pin-shaped parts used in state of the art coat hangers, which is necessary in order to introduce the deformation over a sufficient length, such that the mechanical stress which will occur in the plastic body will be spread out sufficiently. The aim of the deformation is to provide hook 4 with a certain level of stiffness, when it is turned in cylindrically shaped reinforcement 2, to such an extent that a torque of for example 1 Nm is necessary to rotate it.

FIG. 2 represents this embodiment in a cross-section AA′ in FIG. 1, with plastic body 1, cylindrically shaped reinforcement 2 and pin-shaped part 7.

FIG. 3 represents this embodiment in cross-section AA′ on a different scale in which a possible more or less elliptically shaped deformation of pin-shaped part 7 in cylindrically shaped reinforcement 2 shown severely exaggerated. Before the distortion is made, the outer diameter of pin-shaped part 7 and the inner diameter of the centrally located cavity 3 substantially correspond. Given this, it will be clear that the shoulders 7a,7b will press against the wall of plastic body 1 and that this wall will elastically deform, which generates a friction torque which will remain present, even after hook 4 has been rotated a large number of times. The distortion can easily be made by pressing the pin-shaped part between two properly shaped dies in a well-defined manner, before it is introduced in cylindrically shaped reinforcement 2. The distortion can be applied over a length of for example 20 mm, in such a way that the diameter of pin-shaped part 7 locally is reduced by for example 5%.

FIG. 4 shows an alternative embodiment of a coat hanger according to the invention, in which an arc-shaped deformation of the pin-shaped part, is shown severely exaggerated. For the manufacture of a hook 4, a length of wire-shaped base material is provided with a foot 6 and a pin-shaped part 7. In order to realise a predefined friction between cylindrically shaped reinforcement 2 and pin-shaped part 7, a part of pin-shaped part 7 is slightly bended in a longitudinal direction so as to obtain an arc-shape 8, for example by pressing it between two properly shaped dies in a well defined manner. Due to its shape, a central part of pin-shaped part 7 will press against a central part of the wall of the centrally located cavity 3, while the extremities will be pressed against the opposite wall. This results in an elastic deformation of the walls when hook 4 is rotated, which generates a friction torque which will remain present, even after hook 4 has been rotated a large number of times.

FIG. 5 represents an alternative embodiment of a coat hanger according to the invention, in which only a small part 9 is given an arc-shaped deformation, which is shown here severely exaggerated. In this realisation the arc has so to speak not been finished completely. Care has been taken however to keep foot 6 in place, such that hook 4 can be pressed into centrally located cavity 3 without problems with existing manufacturing equipment. For the manufacture of a hook 4, a length of wire-shaped base material is provided with a foot 6 and a pin-shaped part 7. In order to realise a predefined friction between plastic body 1 and pin-shaped part 7, a part of pin-shaped part 7 is slightly bended in a longitudinal direction so as to obtain an arc-shape 9, for example by pressing it between two properly shaped dies in a well defined manner. The friction, which gives the desired friction torque, is especially realised between the arc-shaped part of pin-shaped part 7 and the neighbouring plastic. Moreover, the position of foot 6 will change when hook 4 is rotated, which introduces additional friction in the cavity in which it is located. A favourable mechanical life of the pivot joint and a sufficiently large friction torque is obtained by providing pin-shaped part 7 with an arc which bulges about 2-10% of the diameter of pin-shaped part 7, dependent upon the choice of the type of plastic and of the material of hook 4. Moreover, it is of importance that the surface of pin-shaped part 7 shows practically no grooves in a longitudinal direction, because these would on the long run reduce the additional friction and would detrimental to the mechanical life of the pivot joint.

It is also possible to produce a hook as shown in FIG. 1 to FIG. 5 beforehand and to produce plastic body 1 around it, for example in an injection moulding process. The functioning will then remain the same, but the coat hanger will then show more pronounced preferred positions. The coat hanger shown in FIG. 3 will for example have two preferred opposite positions, while the coat hangers shown in FIG. 4 and 5 will show only one preferred position.

FIG. 6 represents in cross-section a further possible embodiment of a plastic body 1, according to which plastic body 1 can be made of a cheap, non-elastic plastic. For mounting a steel hook, plastic body 1 is provided with a plastic bush 10, which is preferably slightly tapered. In plastic bush 10 a plastic plug can be placed, which is preferably also slightly tapered and which is made of elastic plastic, which can contain a hook according to the invention. Plastic bush 10 can be fitted into the well-known in cross-section U-shaped coat hanger or I-shaped coat hanger but also in other, arbitrarily shaped coat hangers.

FIG. 7A represents in side view a plastic plug 11, provided with a steel pin 12, on which a hook shaped part 5 can be bent afterwards. Pin-shaped part 7 and a foot 6 form part of steel pin 12. Pin-shaped part 7 has been slightly deformed in a manner as described before, such that a desired friction is obtained. In the embodiment shown here, plastic plug 11 is provided with a recess 13, which can co-operate with a complementary projection, not shown here, made on the inside of plastic bush 10, for preventing plastic plug 11 from rotating in plastic bush 10.

FIG. 7B represents in side view a plastic plug provided with a steel pin 12, on which a hook shaped part 5 can be bent afterwards. In the embodiment shown here, plastic plug 11 is provided with a projection 14, which can co-operate with a complementary recess, not shown here, made in the inside of plastic bush 10, again for preventing plastic plug 11 from rotating in plastic bush 10.

FIG. 8A represents in a cross-section AA′ in FIG. 7A the plastic plug 11 with in it the recess 13 and FIG. 8B represents in a cross-section BB′ in FIG. 7B the plastic plug 11 with on it the projection 14.

Of course, it is possible to select another type of connection for plastic plug 11 in plastic bus 10, for example a snap-in construction. It is possible then to insert plastic plug 12 from above into plastic bus 10. The advantage would be that hook-shaped part 5 could be bent in shape beforehand.

1. Coat hanger, provided with a plastic body and a metal hook, which hook has a pin-shaped part which is mounted for rotation round a longitudinal axis in a centrally located cavity in the plastic body, with the foot anchoring the hook in the plastic body, characterized in that the pin-shaped part is provided with friction means, for realising a predetermined friction between the hook and the plastic body.

2. Coat hanger according to claim 1, characterized in that the friction means comprise a mechanical deformed part of the pin-shaped part.

3. Coat hanger according to claim 2, characterized in that the pin-shaped part has a length of at least 20 mm.

4. Coat hanger according to claim 3, characterized in that the pin-shaped part has at least partly a non-round cross section.

5. Coat hanger according to claim 3, characterized in that the pin-shaped part is at least partly provided with an arc-shaped deformation in a longitudinal direction.

6. Coat hanger according to claim 5, characterized in that the foot is provided with radiallyextending grooves and the plastic body with complementary grooves.

7. Coat hanger according to claim 3, characterized in that at least a part of the plastic body, which co-operates with the pin, shaped part is made of elastic plastic, like polypropylene, polyethylene or a styrene-butadiene-styrene with polystyrene mixture.

8-10 (cancelled)
